(19) United States
(12) Patent Application Publication
(10) Pub. No.: US 2003/0145325 A1
(43) Pub. Date: Jul. 31, 2003

(54) Method and system for presentation of pre-generated programming information

(76) Inventors: Paul Finster, New York, NY (US); Yoav Morahg, New York, NY (US); David Ruderman, Brooklyn, NY (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/066,363

(22) Filed: Jan. 31, 2002

(51) Int. Cl. H04N 7/173; H04N 5/445

(52) U.S. Cl. 725/46; 725/87; 725/40

(57) ABSTRACT

A method and system for the presentation of pre-generated customized programming information to viewers. The system receives a request for programming information, and provides, in response to the request, at least one of a plurality of customized views of the programming information to the viewer, wherein the plurality of views are generated according to viewer characteristic data before receipt of the request. In one embodiment, the viewer characteristic data includes the options available to the viewer or the level of customization available to the viewer, while at least one of the customized views of the programming information may include a collection of Web page listings.

### RELATED APPLICATIONS

The present application is related to the following commonly owned and assigned patent applications, all of which are incorporated herein by reference and filed Jan. 31, 2002:

GIST-001/00US, entitled System and Method for Generating Customized EPG Data and Application Programs;

GIST-002/00US, entitled Method and System for Presentation of Pre-Generated Programming Information; and

GIST-003/00US, entitled Method and System for Optimal Grid Alignment.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent files or records, but otherwise reserves all copyright rights whatsoever.

### FIELD OF THE INVENTION

The present invention relates to the presentation of pre-generated customized programming information to viewers.

### BACKGROUND OF THE INVENTION

In recent years, entertainment program viewers have been provided with increasing numbers of viewing choices. For example, several cable television (“CATV”) providers now offer more than 100 channels of programming to their subscribers. Digital cable television providers offer more than 200 channels, and satellite television providers offer over 500 channels to their subscribers. The Internet and the increasing availability of broadband communications have introduced the availability of a practically unlimited number of sources of streaming video, representing an almost limitless diversity of content, from drama to sporting events to documentaries. Viewers can receive programming information via traditional print media or, for example, electronic programming guides (EPGs) that may be provided by a program provider directly through a television (“TV”) or a set-top box (STB) (e.g. an HTTP/HTML application, like a Web browser, than enables a TV to become a user interface to the Internet).

One approach to displaying programming information to viewers (e.g. via electronic program guides, Internet programming guides, etc.) relates to customizing program listings for individual viewers. Under this approach, when a program listings server receives a request for programming information from a viewer, the server may tailor the substance or layout of the resulting programming information to suit the needs or desires of the specific viewer requesting the information. One disadvantage to this approach is the need for the program listings server to customize programming information upon each viewer request. This customization process lengthens the server's response time and requires the server to run expensive high-end application servers to control the processing load.

In other embodiments, present systems require the STBs to customize the program listing information for the viewer. For example, the program listings server could provide an unfiltered stream of programming data to the viewer's STB. The STB would be forced to parse the entire stream of data and determine which portions to display. Because the STB must parse the entire stream of program data, the STB should know the structure of the data and must have the logic to drive the parsing. Unfortunately, this logic is often proprietary and prevents standardization across different types of STBs. Additionally, by sending an unfiltered stream of programming data, the program listings server is using a great deal of bandwidth.

Accordingly, there is a need in the art for a system and method that enables a program listings server to customize programming information for individual viewers in a faster and more effective and efficient manner.

### SUMMARY OF THE INVENTION

Exemplary embodiments of the present invention that are shown in the drawings are summarized below. These and other embodiments are more filly described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention is directed to a method and system for generating, displaying, and disseminating customized program listings information that may embody all or many of the possible permutations for a given set of viewers. The invention enables logic for the listings pages that are constructed remotely to be managed by central servers, thus allowing remote display devices to merely enable presentation without logical understanding or parsing of the original data. In essence, one embodiment of the present invention includes statically built permutations of program listings (in HTML, JSP, JavaScript, XML, Cascading style sheets, XSL, etc.) stored on a central server such that set-top box clients can create unique links to those pages at runtime.

In another embodiment, the invention presents the customized program listings information by receiving a request for programming information and providing, in response to the request, at least one of a plurality of customized views of the programming information to the viewer, wherein the plurality of views are generated according to viewer characteristic data. Notably, in this embodiment, the STB does not need to parse the programming information.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram that depicts a network architecture in accordance with an embodiment of the present invention;

FIG. 2 is a flow chart that illustrates a process for presenting customized program listings information in accordance with an embodiment of the present invention; and

FIG. 3 is a screen shot that depicts a customized view of programming information in accordance with an embodiment of the present invention

### DETAILED DESCRIPTION

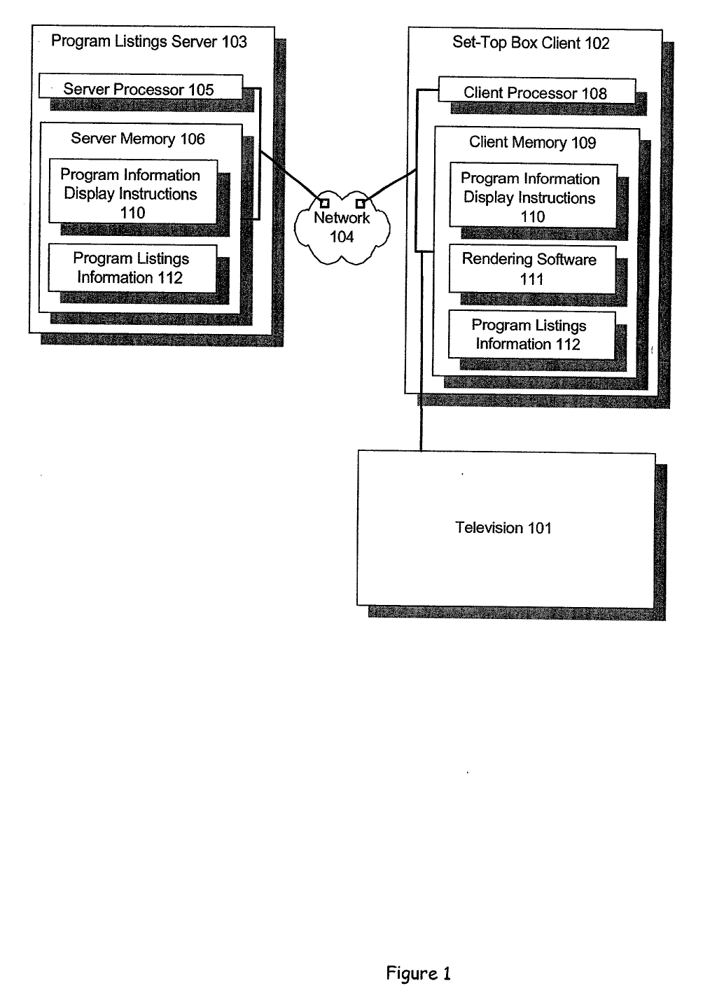

Referring now to the Drawings, a network architecture in accordance with one embodiment of the present invention is shown in FIG. 1. Television 101 is coupled to set-top box client 102, which in turn is coupled to program listings server 103 through network 104. The set-top box client 102 can run on a browser-like application or a programming language engine such as a JavaScript engine. In other embodiments, the set-top box client functionality and the display can be incorporated into a handheld device, PDA, wireless remote, wireless phone, etc.

Program listings server 103 includes server processor 105 coupled to server memory 106. Server processor 105 can include, among others, a general purpose microprocessor or an Application Specific Integrated Circuit (“ASIC”) that embodies at least a part of the method in accordance with an embodiment of the present invention in its hardware and/or firmware. An example of an ASIC is a digital signal processor. Likewise, server processor 105 can also be a combination of microprocessors and/or ASICs.

Server memory 106 can be any device adapted to store electronic information, such as Random Access Memory, Read Only Memory, a hard disk, a Compact Disk Read Only Memory (CD-ROM), etc. At least part of server memory 106 should be writeable as well as readable. Server memory 106 may store program information display instructions 110 (software) and program listings information 112 that can be downloaded through network 104 to set-top box client 102. Program information display instructions 110 may include HTML code with embedded Javascript for rendering program listings information 112.

Television 101 is viewed by a viewer. Television 101 is an example of a display device on which programs and programming information can be displayed to the viewer. Additional examples of display devices include a computer monitor, a display on a handheld device, a heads-up display, a projection display, etc.

Set-top box client 102 includes a client processor 108 coupled to client memory 109. As with server processor 105, client processor 108 can include, among others, a general purpose microprocessor, or an ASIC that embodies at least a part of the method in accordance with an embodiment of the present invention in its hardware and/or firmware. Likewise, client processor 108 can be a combination of microprocessors and/or ASICs.

Client memory 109, like server memory 106, can be any device adapted to store electronic information, such as Random Access Memory, Read Only Memory, a hard disk, a Compact Disk Read Only Memory (CD-ROM), etc. At least part of client memory 109 should be writeable as well as readable. Client memory 109 may store rendering software 111 adapted to be executed by client processor 108, along with program information display instructions 110 and program listings information 112 that may be downloaded from program listings server 103. Rendering software 111 may render program listings information 112 in accordance with program information display instructions 110.

Rendering software 111 can also be interactive, and receive and process input from the viewer (e.g., from a television remote control, a keyboard, a mouse, a handheld wireless device, etc.) rendering software 111 may share the functions of well-known browser software, such as the Internet Explorer, manufactured by the Microsoft Corporation of Redmond, Wash.

Network 104 can be any network and/or system of networks. Examples of network 104 include the Internet, a wireless network, the Public Switched Telephone Network (“PSTN”), a Local Area Network (“LAN”), a Wide Area Network (“WAN”), a wireless network, a WAP-based network, a proprietary network, etc.

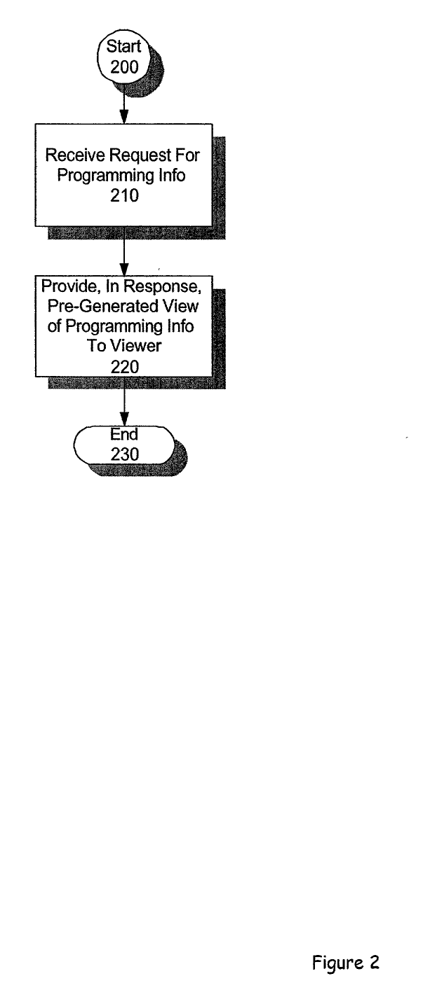

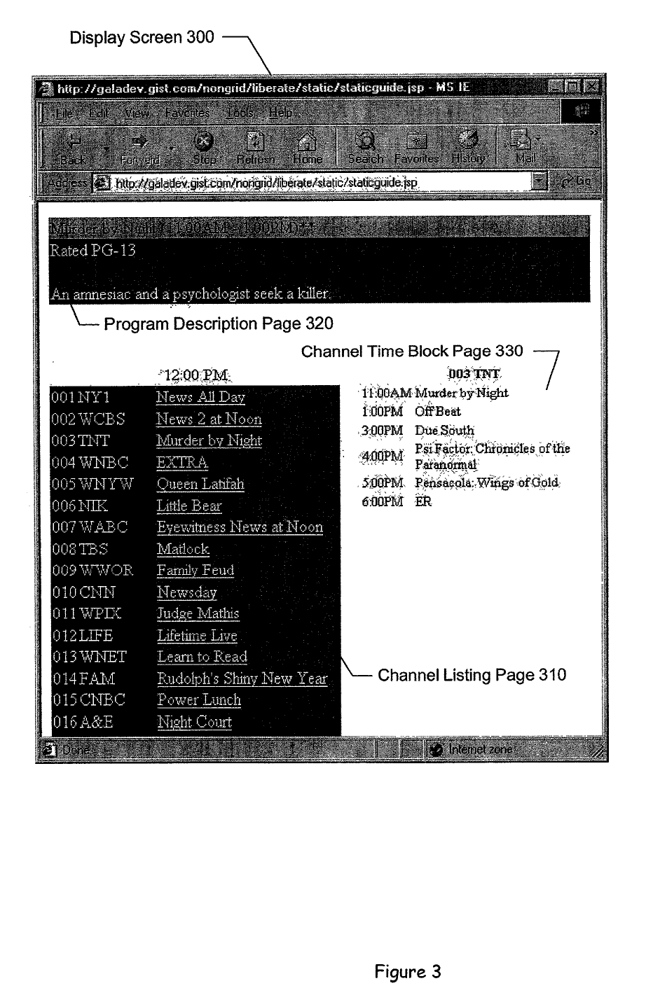

FIG. 2 illustrates a process for presenting customized program listings information in accordance with an embodiment of the present invention, with FIG. 3 illustrating an exemplary display screen of the resulting program listings. According to this process, server processor 105 receives a request for programming information (step 210). In response to the request, server processor 105 provides a pre-generated view of the requested programming information to the viewer (step 220). Alternatively, in response to the request, the server processor could combine pre-generated information with dynamically-generated information to provide a view of the requested information.

One method to accomplish this is to generate all possible views, or a subset thereof, of the programming information given the possible unique viewer characteristic data. For example, options for displaying the program listing information could include display options such as “Movies Only,” “No Sports,” “Parental Restrictions,” “Grid Format,” “List Format,” “Frame Format,” “Selected Channels,” “Channel Sequence,” “Display Hours,” “Color Preference,” etc. Other options could be linked to the capabilities of the set-top box client 102 rather than viewer preferences.

These varied views of the program information could be included in HTML pages with appropriate links between HTML pages, in JavaScript programs, or in data structures such as JavaScript data structures. Additionally, these links could reflect the options or level of customization available to viewers. In using this technique, the work is done at page generation time and the set-top box client 102 is not forced to parse the data at runtime. In one embodiment, program listings server 103 could run simple web (HTML) servers, which are cheaper than high-end application servers, and viewers could run a simple web browser client.

Clients that run on set-top boxes and share the same cable headend typically fetch pages through a proxy or caching server and can benefit from data caching. Since set-top boxes have mostly the same program listings attributes (same channels, same time zone, same programming), they are likely to be requesting the same customized static pages. To take advantage of these repeated requests, one embodiment of the present invention caches the pre-generated programming information pages for quick retrieval.

FIG. 3 illustrates display screen 300, which is a Web browser window opened by rendering software 111 to present the pre-generated view of programming information to a viewer. Display screen 300 shows rendered content inside three borderless frames: channel listing page 310, program description page 320 and channel time block page 330. Although not shown, the viewer is pointing the mouse at the “Murder by Night” link next to the channel “003” “TNT” station. The following HTML code illustrates program information display instructions 110 in client memory 109, which is used to render the content of display screen 300:

| | |
|---|---|
| 1 | <HTML> |

```
  2
  3
```

| | |
|---|---|
| 4 | <FRAMESET rows=“125, *” frameborder=0 framespacing=0> |

| | |
|---|---|
| 5 | <FRAME src=“progdescarea.jsp” name=“progdescframe” scrolling=no> |
| 6 | <FRAMESET cols=“300, *” frameborder=0 framespacing=0> |

| | |
|---|---|
| 7 | <FRAME src=“/userid/chanlist/NY31534/200012211200.html“” |

name=“mainframe” scrolling=no>

| | |
|---|---|
| 9 | <FRAME src=“empty. html” name=“programframe” scrolling=no> |

| | |
|---|---|
| 10 | </FRAMESET> |

| | |
|---|---|
| 11 | </FRAMESET> |

12

| | |
|---|---|
| 13 | </HTML> |

The HTML code above defines three frames for rendering. Channel listing page 310 (lines 7-8) points to the source “/userid/chanlist/NY31534/200012211200.html”, program description page 320 (line 5) points to the source “progdescarea.jsp”, and channel time block page 330 (line 9) points to source “empty.html.” This code is provided to set-top box client 102 by program listings server 103 after a viewer requests channel listings for headend ‘NY31534’ for Dec. 21, 2001 at 12 pm. Notably, the “userid” can be replaced dynamically with the appropriate unique ID such that the URL be expanded to build a link to a pre-generated HTML file.

For each page rendered in display screen 300, unique characteristics which uniquely identify a page are used to name the page which also becomes part of the URL of the page. In other embodiments, the URL is generated at run-time either on the set-top box client 102 or the program listing server 103. These pages can be generated before they are requested by a viewer and placed on a web server ahead of time. The characteristics include, but are not limited to, the headend id which in turn can identify a list of channels, the specific channel requested, the specific start time for a channel and other requested information.

In this manner, static channel listing page 310 can be pre-generated. It contains a list of all unique channels and programs which are airing at a date and time, and can be stored in a hierarchy of directories which correspond to known characteristics. For example, as seen on line 7, channel listings for headend ‘NY31534’ for Dec. 21, 2000 at 12 pm is placed in file/source‘/static/chanlist/NY31534/200012211200.HTML’. These file paths are URL links that are to be used to access these HTML pages. (Of the string ‘200012211200’, the first eight digits are the year/month/date, and the last four digits are the time in 24 hour notation).

To further the example, the following HTML code controls the portion of channel listing page 310 relating to the station “TNT” on channel “003”:

| | |
|---|---|
| 14 | <TD bgcolor=black colspan=“1”> <FONT color=white>003</FONT> </TD> |
| 15 | <TD bgcolor=black colspan=“4”> <FONT color=white>TNT</FONT> </TD> |
| 16 | <TD bgcolor=blue colspan=“5”> <FONT color=white> <A HREF=“javascript:void (0)” |

| | |
|---|---|
| 17 | onMouseOver=“top.progdescframe.location=‘../../../progdesc/11164/MV0271320 |

| | |
|---|---|
| 18 | 000/200012211200.html‘;top.programfram.location=’../../../block/11164/ |
| 19 | 200012211200.html‘“> |

| | |
|---|---|
| 20 | Murder by Night</A> </FONT> </TD> |

Program description page 320, which contains detailed information about a program including the channel number, start and end times, the cast, run time, and rating, can also be similarly created ahead of time and named appropriately so it can be referenced using its unique attributes. For example, the description of the program on channel “003” with id ‘11164’ and program identifier ‘MV0271320000’, starting Dec. 21, 2001 at 12 pm, is placed in file ‘/static/progdesc/11164/MV0271320000/200012211200.HTML’ using a similar methodology as above. As lines 17-18 illustrate, by moving the mouse over that entry on channel listing page 310, program description page 320 (via the onMouseOver attribute) renders the correctly referenced file/source sought by the viewer. Since all the attributes which make up the file name are known when channel listing page 310 and program description page 320 are created, those pages can be generated with URL links to the specific program descriptions.

Similarly, additional pages like channel time block page 330 can be generated ahead of time. This page lists what programming is on just one channel for a certain number of hours starting at a given date time. For example, channel with id ‘11164’ for Dec. 21, 2001 at 12 pm is placed in file “/static/block/11164/200012211200.HTML” using a similar methodology as above. Again, as lines 18-19 illustrate, by moving the mouse over that entry on channel listing page 310, channel time block page 330 (via the onMouseOver attribute) renders the correctly referenced file/source sought by the viewer. This file could also use the same file naming scheme to have static HTML links to program descriptions.

In alternative embodiments, the customized views of the programming information may be dynamically pulled from a central server or pushed—possibly preset according to a schedule—from a central server. In either embodiment, the content can be stored on the set-top box client 102 for subsequent retrieval. The construction of the listing pages may also be triggered by the request for a first page to display.

In conclusion, the present invention provides, among other things, a system and method for presenting pre-generated customized programming information to viewers. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for presenting programming information to a viewer, the method comprising:
identifying a plurality of programming information display options;
generating, at a programming listing server, a first display configuration, wherein the first display configuration corresponds to a first combination of the options included in the plurality of programming information display options;
generating, at a programming listing server, a second display configuration, wherein the second display configuration corresponds to a second combination of the options included in the plurality of programming information display options;
storing the first display configuration and the second display configuration in a memory associated with the programming listing server;
selecting one of the first display configuration and the second display configuration to send to the viewer, wherein the first display configuration is sent to the viewer responsive to the viewer being associated with the first combination of the options and wherein the second display configuration is sent to the viewer responsive to the viewer being associated with the second combination of the options; and
providing the selected one of the first display configuration and the second display configuration to the viewer.

2. The method of claim 1, wherein the programming information display options comprise:
a plurality of viewing preferences selectable by the viewer.

3. The method of claim 1, wherein the programming information display options comprise:
a set-top box characteristic.

4. The method of claim 1, wherein the first display configuration comprises:
an HTML page.

5. The method of claim 1, wherein the first display configuration comprises:
JavaScript code.

6. The method of claim 1, wherein the first display configuration comprises:
an XML page.

7. The method of claim 1, wherein the first display configuration comprises:
a JavaScript data structure.

8. The method of claim 1, further comprising:
receiving a request from the viewer f or programming information; and
determining which combination of the options is associated with the viewer.

9. The method of claim 1, further comprising:
generating at the programming listing server an indication to update a viewer-local program listing source; and
determining which combination of options is associated with the viewer;
wherein providing the selected one of the first display configuration and the second display configuration to the viewer comprises:
responsive to the indication, pushing the selected one of the first display configuration and the second display configuration to the viewer-local program listing source.

10. A system for presenting programming information to a viewer, the system comprising:
a processor;
a memory device connected to the processor; and
a plurality of instructions stored on the memory device, the plurality of instructions configured to cause the processor to:
generate a first display configuration, wherein the first display configuration corresponds to a first combination of display options included in a plurality of display options;
generate a second display configuration, wherein the second display configuration corresponds to a second combination of display options included in the plurality of display options;
select one of the first display configuration and the second display configuration to send to the viewer, wherein the first display configuration is sent to the viewer responsive to the viewer being associated with the first combination of display options and wherein the second display configuration is sent to the viewer responsive to the viewer being associated with the second combination of display options; and
initiate transfer of the selected one of the first display configuration and the second display configuration to the viewer.

11. A method for presenting programming information to a viewer, the method comprising:
identifying a plurality of programming information display options;
generating, at a programming listing server, a plurality of display configurations, wherein each of the plurality of display configurations corresponds to a set of the plurality of programming information display options;
storing the plurality of display configurations in a memory associated with the program listing server;
selecting one of the plurality of display configurations to send to the viewer, wherein the selected one of the plurality of display configurations corresponds to one set of the plurality of programming information display options associated with the viewer; and
providing the selected one of the first display configuration and the second display configuration to the viewer.

12. The method of claim 11, wherein the plurality of display configurations comprises:
a set-top box characteristic.

13. The method of claim 11, further comprising:
receiving a request from the viewer for programming information; and
determining which of the plurality of programming information display options is associated with the viewer.

14. The method of claim 11, further comprising:
caching, at the program listing server, the selected one of the plurality of display configurations.

15. A system for presenting programming information to a viewer, the system comprising:
means for identifying a plurality of programming information display options;
means for generating a plurality of display configurations, wherein each of the plurality of display configurations corresponds to a set of the plurality of programming information display options;
means for selecting one of the plurality of display configurations to send to the viewer, wherein the selected one of the plurality of display configurations corresponds to one set of the plurality of programming information display options associated with the viewer; and
means for providing the selected one of the first display configuration and the second display configuration to the viewer.
